(19) United States
(12) Patent Application Publication
(10) Pub. No.: US 2019/0199763 A1
(43) Pub. Date: Jun. 27, 2019

(54) SYSTEMS AND METHODS FOR PREVIEWING CONTENT

(71) Applicant: MINDHIVE INC., New York, NY (US)

(72) Inventors: Oya Demirli, New York, NY (US); George Dalke, Claremont, NH (US)

(21) Appl. No.: 15/852,819

(22) Filed: Dec. 22, 2017

(51) Int. Cl. H04L 29/06; H04L 29/08

(52) U.S. Cl. CPC H04L 65/4023; G06Q 50/01; H04L 67/10; H04L 65/602

(57) ABSTRACT

The invention generally relates to tools for providing shorter media content previews having smaller file sizes to allow for audiences to preview media before or during downloading of the complete file. Methods are provided for intelligent selection of key content portions for inclusion in abridged previews. Interactive previews capturing the scope of the complete content but reducing file size through reduced frame-rates, compression, and/or resolutions are also disclosed.

### FIELD OF THE INVENTION

The invention generally relates to previewing multimedia content.

### BACKGROUND

More and more people are creating and sharing complex media via social networking sites and other platforms, often over wireless networks on mobile devices. The computing power of those devices and the media programs running on them as well as the image quality that modern mobile devices are capable of means that the file sizes of shared media are large and getting larger. Furthermore, the attention span of individuals used to instant gratification and constant connectivity and entertainment is small. In using current technologies, consumers of digital media must wait for files to download before viewing or interacting with them, often being shown only a still image from the beginning or end of the media file or, worse yet, an hourglass or other loading icon. User's attention is bound to be lost in those circumstances and, furthermore, they are generally forced to download entire large files before they can interact with them and determine whether are truly interested in the media. Because there is no means of accurately previewing the media before downloading, user's time and bandwidth (and, accordingly, money) can often be wasted downloading media they are not truly interested in. Additionally, media file sizes and complexity are increasing in step with or even outpacing increases in download speeds. Accordingly, the problem is not being addressed through advances in mobile connectivity, especially in many parts of the world that do not have access to the most advanced mobile networks.

### SUMMARY

The present invention provides concise media previews that can highlight key portions of the larger media file and, in some instances, allow for user interaction before downloading the media in its entirety. The previews may provide for user interaction and entertainment while waiting for the full download or may allow a user to evaluate the media without committing to a full download. The invention provides file structures and methods for selecting key portions that allow for simple and effective creation of powerful and highly representative media previews.

Because the preview files are much smaller in size than the full media content, they can be downloaded and transferred rapidly and without great bandwidth use or associated costs. Because the preview files are curated to show key portions of the content or, in certain embodiments, to allow comprehensive user interaction (e.g., video or image manipulation such as scrubbing, panning, rotation, zooming, etc.), they provide the user with the tools necessary to evaluate the content to determine if they are truly interested and would like to spend the time and money to download the full-size content. Furthermore, the preview models described herein provide engaging user entertainment to pass the time while the full-size content downloads in the background. Additionally, full-size content fills in the missing portions from the preview, in other words, the content portions (e.g., video clips, images, audio, or even individual pixel data) provided in the preview are saved and incorporated into the full-size content so as not to be redundantly downloaded, further conserving bandwidth and time. Because systems and methods of the invention incorporate the preview content into the full-size content file, they can also provide for a seamless transition from preview to full-size content files as the user is experiencing the content.

One important aspect of the present invention is the ability to identify key portions of the content to include in a preview. While in certain embodiments portions for a preview may be selected at random (either temporally or spatially) or according to a fixed template, portions may also be intelligently selected based on certain criteria. For example, actions taken during the creation of the content such as zooming in during video creation, pausing or slowing down during video creation, or even accelerometer or other sensor data taken from a smart phone during video creation may be used to indicate portions of video content that are of particular interest to select for inclusion in a preview.

In certain embodiments, content creators may manually select one or more portions of content to include in a preview. In other embodiments audiences may identify portions of content that are most interesting that may be included in previews for future audiences. That process may be continually updated such that previews are created based on the most current audience preferences. Audience preferences may be determined manually through positive or negative indications received from a content viewer or may be determined automatically based on actions taken by viewers (e.g., fast forwarding through or skipping certain segments may remove them from previews while re-watching, pausing, or slowing down certain segments may cause them to be included in future previews). In certain embodiments, key portions may be determined based on audience preferences (input manually or mined from user data).

In certain applications, systems and methods of the invention may be used to create previews of component-based content as described in U.S. Pat. No. 9,672,377, the contents of which are incorporated herein by reference. Content can be compiled from constituent components with separate authorship and privacy parameters. Components may comprise separate audio, text, video, image, or other types of media and final content may be synthesized by combining the components, along with subsequent editing parameters, at an end user's device for viewing. In such instances, portions of the content for previews may be component-based (e.g., including audio and text-based components while excluding image based components)

Components may be selected for inclusion in a preview by criteria such as size, where smaller file-size components such as text components may be included by default as they will not significantly affect download speeds or transfer costs. Other criteria may include the presence of a narration (e.g., overlaid text, audio, image, or video from an author commenting on underlying content) or heavily edited portions (e.g., spatial or temporal portions of the content that are the subject of the most editing parameters). Component temporal length or spatial size may be used to determine inclusion in a preview. Portions of the final content may be included in a preview based on the number of components temporally or spatially (e.g., a 10 second portion of the media content that has 5 different components will be deemed more important and previewed over a portion that includes only 1 component such as a background video). Preview portions may be selected based on the presence of transition effects used in the content and as described in U.S. Pre-Grant Publication No. 2016/0014160, incorporated herein by reference. In other instances, preview components may be selected based on their respective authors, either manually or automatically based on author popularity or other indicators.

In certain embodiments content portions may be selected for preview based on analysis of the content including facial, object, or pattern recognition where, for example, portions including people's faces may be deemed more important and included in a preview. Audio cues such as inflection points, or audio volume (e.g., loud cheering at an event) may be used to determine portions for inclusion in a preview. Environmental cues may be used in certain embodiments where, for example, motion of the recording device can be used (e.g., portions blurred due to quick movements can be excluded while portions recorded immediately before or after abrupt movements of a camera may be included as likely important). Device cues such as camera orientation or focus may be used in certain embodiments.

As noted earlier, systems and methods include static, trailer-type previews as well as interactive previews that include interactive functions present in the final content (e.g., ability to zoom, pause, fast forward, rewind, pan, rotate, scrub to any point). In such interactive preview models, file size and bandwidth needed for download may be reduced (while download speeds are increased) through reducing resolution, compression, and/or frame rate of the content. Accordingly, the preview appears to a viewer to be unchanged in temporal and spatial scope from the full content, allowing the viewer a rewarding interactive experience, albeit at a reduced quality. In certain embodiments, framerate, resolution, and/or compression may be variable for different portions of the content. Those portions may be selected according to any of the criteria discussed above or below with respect to the trailer-type previews. In other words, the key or critical portion selection criteria described above may be used to identify components or sections of the content that are maintained at full frame rate in the preview while less important portions are transferred at a reduced framerate.

With any type of preview described herein, during the preview, the full-size media content can continue downloading in the background. The omitted frames, pixels, or sections can be downloaded individually to fill in the portions missing from the preview so as not to require duplicative downloading of the preview portions. In interactive preview models, the missing frames or pixels can be filled in while the user is interacting with the preview so that the user experience is seamless. Critical or important portions or components (identified using the criteria discussed above) may be used to determine order of full quality downloads so that the most important content portions reach full quality first. In order to avoid unnecessary downloading, various strategies can be used to determine when to start and stop full length and quality downloads of previewed content.

In certain embodiments, the preview systems and methods described herein may be applied to recapping live-stream media in a concise manner to bring late-comers up to date on what they've missed.

In certain aspects, the invention includes a method for previewing content over a communication network. Steps of the method include receiving at a first computing device coupled to a communication network a request for a preview of a piece of content; identifying key segments of the piece of content at the first computing device based on one or more criteria; sending the key segments to a second computing device over the communication network; assembling the key segments at the second computing device to create the preview; sending a request for the piece of content from the second computing device to the first computing device over the communication network; sending remaining segments from the first computing device to the second computing device over the communication network; and combining the remaining segments with the key segments at the second computing device to recreate the piece of content.

In certain embodiments, the piece of content one or more of an image, a video, a document, or an audio clip. The piece of content may comprise a plurality of components selected from an image, a video, a document, an audio clip, or a combination thereof and the second computing device is operable to assemble the plurality of components to recreate the piece of content. The key segments may be one or more of the plurality of components. The one or more criteria can comprise component type or component size. The one or more criteria may comprise a recording parameter. The recording parameter may comprise a zoom, focus, recording speed, or movement of the recording apparatus. The recording parameter can be determined from a sensor or input devices on a recording apparatus.

In certain embodiments, the sensor or input device on the recording apparatus may be a camera and the recording parameter may be an expression or movement in author's face observed using the camera. The recording parameter can be determined through analysis of the piece of content. The one or more criteria may comprise an analysis of audience preferences. The audience preferences can be determined from prior audience interactions with the piece of content. The audience preferences may be determined from prior audience interactions with other content by a user associated with the second computing device.

In various embodiments, the one or more criteria may be determined from analysis of the piece of content for one or more of an image of a category of object, an image of a specific object, or an audio cue.

In certain embodiments, the category may be a face, the specific object may be the face of a specific individual (e.g., the user associated with the second computing device or the content author), and/or the audio cue may be an inflection point in recorded speech. The piece of content may be still recording at the time of preview creation and the key segments of the piece of content are identified and sent based on one or more criteria and an analysis of the piece of content at the time of the identifying and sending steps.

Aspects of the invention include a method for previewing content over a communication network. The method may comprise receiving at a first computing device coupled to a communication network a request for an interactive preview of a piece of content; identifying key segments of the piece of content at the first computing device based on one or more criteria; sending the key segments and a reduced number of frames of remaining segments to a second computing device over the communication network; assembling the key segments and the reduced number of frames of the remaining segments at the second computing device to create the interactive preview; sending a request for the piece of content from the second computing device to the first computing device over the communication network; sending remaining frames of the remaining segments from the first computing device to the second computing device over the communication network; and combining the remaining frames with the reduced number of frames of the remaining segments at the second computing device to recreate the piece of content. In certain embodiments, a reduced number of pixels may be sent of the remaining segments.

### BRIEF DESCRIPTION OF THE DRAWINGS

FIG. 1 shows a method of providing a trailer-type content preview.

FIG. 2 shows a method of providing an interactive content preview.

FIG. 3 shows two methods of delivering interactive content previews with either client-side assembly or server-side assembly.

FIG. 4 illustrates a preview creating system according to the invention.

FIG. 5 illustrates the differences between inventive methods and prior preview technologies.

FIG. 6 shows an exemplary computing device displaying a volatility parameter selection screen.

FIG. 7 gives a more detailed schematic of components that may appear within a system.

### DETAILED DESCRIPTION

The present invention provides previews of media content having smaller file sizes and, accordingly, shorter download times but can otherwise offer an end user a comprehensive experience from which to judge whether or not to proceed with a full-file download. Previews of the invention also provide entertainment to users while waiting for a full-size version to download. The systems and methods thereby improve the user experience in consuming media content on-line and reduce unnecessary bandwidth and data usage resulting in time and cost savings.

The previews of the invention are curated to show key portions of the content or, in certain embodiments, to allow comprehensive user interaction (e.g., video or image manipulation such as scrubbing, panning, rotation, zooming, etc.). As such they provide the user with the tools necessary to evaluate the content to determine if they are truly interested and would like to spend the time and money to download the full-size content. If the full content is downloaded, the preview portions are retained and incorporated to avoid redundant data transfers. That action allows for the user to continue to experience the content as the remaining portions fill in, providing a seamless transition between preview content and final content.

One important aspect of the present invention is the ability to identify key portions of the content to include in a preview. Key segments may be temporally or spatially disparate. For example, key segments for inclusion or highlighting in a preview may be video clips such as a 10 second clip of a 40 second piece of video content. An example of a spatially selected segment is a subset of pixels from a larger image such as a 30 second video showing only someone's face taken from a 30 second video showing a larger scene including both the person's face as well as a background scene.

As discussed in more detail below, previews may be made up entirely of key scenes taken out of a larger piece of content and spliced together to form a trailer-type preview. For example, the first 10 seconds, the last 10 seconds, and 10 seconds from halfway through a 2 minute video may be identified as key segments or portions and spliced together to form a 30 second preview of the 2 minute video where, when viewed as a preview plays the first segment, the second segment, and the third 10 second segment in succession.

In other embodiments previews may appear to show the entire piece of content, along with any interactive functionality for user manipulation but still be reduced in size and more quickly transferred through reduction in frame rate, resolution, and/or compression. In such embodiments, the preview content appears to have the same scope as the full-size content. Key portion or segment selection can be applied in such instances by increasing the frame rate or resolution at only the key portions while reducing overall quality at the less important portions that are less likely to be thoroughly examined by an audience. Accordingly, the full user experience can be provided at the critical portions of the content while still reducing file size and transfer times in a preview overall.

In both the preview embodiments discussed above, key portion selection provides an important tool for improving user interactions with a preview while reducing file size and transfer times.

In certain embodiments key portions for a preview may be selected at random (either temporally or spatially). For example four, 10 second portions may be pulled from a 2 minute piece of video content at random for each preview created. In other embodiments key portions may be selected according to a fixed template. For example the first 10 seconds and the last 10 seconds are always selected to preview each piece of video content.

In preferred embodiments, key portions are intelligently selected based on various criteria. For example, actions taken during the creation of the content may be used to identify key portions. Zooming in during video creation, pausing or slowing down during video creation, or sensor data (e.g., accelerometer, GPS, gyroscopic) taken from a smart phone or other camera during video creation may be used to indicate portions of video content that are of particular interest to select for inclusion in a preview. For example, a 10 second portion of a 2 minute second video, 45 second from the start where the creator zoomed in on a face or object may serve as a marker that the 10 second zoomed in portion should be selected as a key segment. Such an indication may be made at the time of the recording (e.g., in response to zoom input or sensor data in the recording device) and such key indicators may be attached to the content prior to uploading or transferring. Author input analysis such as described above may also be determined retrospectively through content analysis (e.g., determining zoomed in or slow motion portions through video or image analysis after creation). Such analysis can take place at a server or other distributing computer prior to creating a preview.

In certain embodiments, key portions of content may be manually selected by previous audiences or by content creators. For example, a content creator or audiences may indicate, through a user interface, particular temporal or spatial portions of the full size content that are more important or should otherwise be included in previews. Such indications may consist of simple yes or no indicators for inclusion in a preview or may comprise a ranking of importance or a tiered system such that variable sized previews may be created based on the indications. For example, if portions of the content are ranked, a preview of a certain size may be created by taking the portions, one at time, by order of ranking or tier classification (e.g., most important, less important, not important) and adding them to the preview until the desired preview file size is reached. Accordingly, using a video example, a thirty second preview may be created, where called for, by taking the highest ranked 30 seconds of the total content while a 10 second preview may be taken using the same assigned rankings by taking only the 10 highest ranked seconds of video.

In certain embodiments, key portions may be determined based on audience preferences (input manually or mined from user data). Based on collected data regarding an audience member's interests from e-mail, social media accounts, or other sources may be used to identify key portions and create a specialized preview of content for that user. For example, a user may have an interest in cats as indicated on a social media profile or evidenced by a high incidence of cats in posted or liked images or cat-related words appearing in e-mail text or social media posts. Accordingly, methods and systems of the invention may identify a 10 second portion of a 3 minute video that includes a cat walking through the field of view as a key component to include in a preview for that user. In some embodiments individual user preferences may be determined from prior interactions with other content and content previews. For example, systems and methods of the invention may include analyzing content components or portions that the user has heavily interacted with in the past for commonalities and then identifying portions in future content that share one or more of those common features as key portions.

Preview portions may be shown in same chronological and/or spatial orientation as in the primary, full-sized content or may be re-ordered to reflect rankings or other criteria (e.g., the most important or key portions are shown first or moved to a different physical position on a display).

As noted above, sensor data from a recording device may be used to determine key portions or rank content portions. In certain embodiments, sensor data may be used to monitor facial or auditory cues from the content author or from audiences. For example, while recording content with a forward facing camera on a mobile device, a secondary camera, facing the author may be used to monitor facial expression or other features relating to the content author. Recognition of facial patterns such as smiles, laughs, frowns, gasps, opening of mouth, etc. may be used to rank or assign key status to the portion of the content being contemporaneously recorded with the forward facing camera. In certain embodiments, the speed or suddenness of facial movements may indicate importance of a content portion being recorded. Similarly, where establishing key portions based on viewer input, a camera or other sensors on the viewing apparatus (e.g., a mobile device having a screen) can be used to evaluate audience reaction and rank portions accordingly. For example, the facial expressions discussed above as well as vibration or motion sensors in the viewing device (e.g., sudden movements of a viewer's phone may indicate a particularly exciting portion while stillness may indicate a particularly interesting portion of the content) may be used to determine the key portions for one or more prior audiences. This data may be then returned to a server or other content-distributing computer for use in creating previews for future viewers.

Sensors may include microphones picking up audio cues from authors or viewers through word recognition (e.g., viewer or author key words such as wow, incredible, etc.) or through tone analysis (e.g., inflection points, increased pace of speech, changes in pitch, etc.). Those cues may be analyzed and used to assign key status to the corresponding portion of the content being recorded or viewed.

Audience data may also indicate key portions for future previews through analysis of audience interaction with the viewer interface. For example, portions that are commonly fast forwarded over or skipped may be indicated as less important and left out of previews while portions where a viewer heavily interacts with content controls (e.g., re-watching, slowing down, panning to, zooming in, or otherwise manipulating) may be indicated as more important.

Where audiences identify portions of content that are most interesting through either sensor data or manually, those indications may be continually updated such that previews are created based on the most current audience preferences.

In certain applications, systems and methods of the invention may be used to create previews of component-based content as described in U.S. Pat. No. 9,672,377, the contents of which are incorporated herein by reference. Content can be compiled from constituent components with separate authorship and privacy parameters. Components may comprise separate audio, text, video, image, or other types of media and final content may be synthesized by combining the components, along with subsequent editing parameters, at an end user's device for viewing as discussed below. In such instances, portions of the content for previews may be component-based (e.g., including audio and text-based components while excluding image based components). For example, components may be prioritized for preview inclusion based on type or size or presence of transition or transformation effects. In certain embodiments, components may be selected for inclusion in a preview by criteria such as size, where smaller file-size components such as text components may be included by default as they will not significantly affect download speeds or transfer costs. Other criteria may include the presence of a narration (e.g., overlaid text, audio, image, or video from an author commenting on underlying content) or heavily edited portions (e.g., spatial or temporal portions of the content that are the subject of the most editing parameters). Component temporal length or spatial size may be used to determine inclusion in a preview. Portions of the final content may be included in a preview based on the number of components temporally or spatially (e.g., a 10 second portion of the media content that has 5 different components or a single quarter of a viewing screen having 5 components will be deemed more important and previewed over a portion that includes only 1 component such as a background video). Preview portions may be selected based on the presence of transition effects used in the content and as described in U.S. Pre-Grant Publication No. 2016/0014160, incorporated herein by reference. In other instances, preview components may be selected based on their respective authors, either manually or automatically based on author popularity or other indicators.

In certain embodiments content portions may be selected for preview based on qualitative analysis of the content itself including facial, object, or pattern recognition where, for example, portions including people's faces may be deemed more important and included in a preview. Audio cues such as inflection points, speech recognition tied to key words, or audio volume (e.g., loud cheering at an event) may be used to determine portions for inclusion in a preview. Environmental cues may be used in certain embodiments where, for example, motion of the recording device can be used (e.g., portions blurred due to quick movements can be excluded while portions recorded immediately before or after abrupt movements of a camera may be included as likely important). Device cues such as camera orientation or focus may be used in certain embodiments.

After determining key portions of a piece of content, those portions may be compiled into a trailer-type preview and sent to an audience member's device for viewing prior to or during full content download. Alternatively the key portions, especially in a multi-component content model as described herein, may be selected and sent to an audience member's device for compilation into a trailer-type preview at the client side as opposed to compilation at the server side. One advantage of compiling at the viewer's device is the ability to avoid redundant downloads. For example, components or content portions not included in the preview can be separately sent and incorporated with the already received key preview portions to form the full-size content. If the preview is compiled at the server side and then sent to an audience member as a single file (e.g., an MPEG video), those previewed portions will have to be transferred again in the context of the full content.

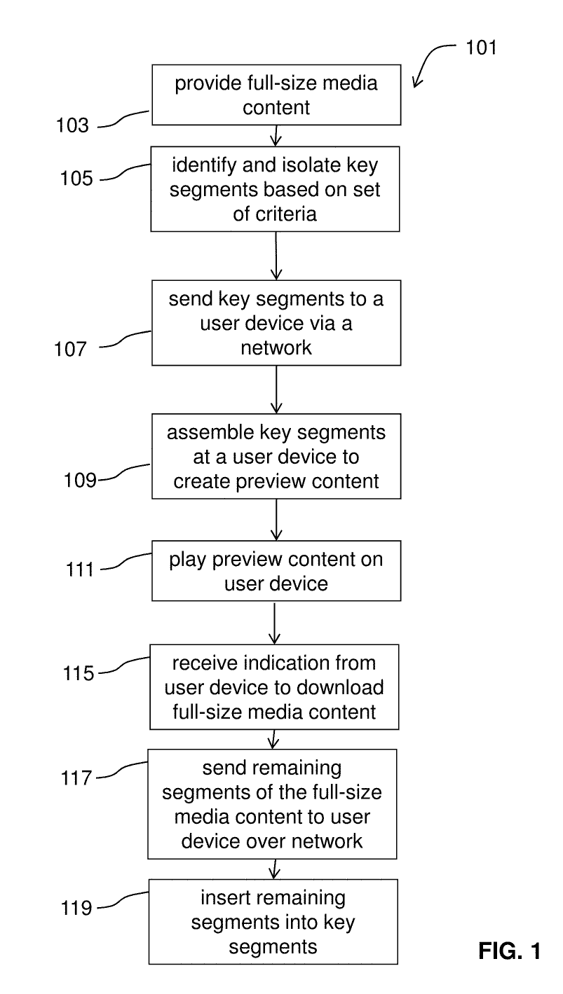

An exemplary trailer-type preview method 101 of the invention is diagrammed in FIG. 1. Full size media content is provided 103 and key segments are identified an isolated 105 according to any of the criteria and methods described above. The key segments are then sent to a user device via a network 107. The user device is then operable to assemble the key segments to create a trailer-type preview 109. The user device can then play the preview 111. An indication from the user device can then trigger the download of the remaining pieces of the content that were not sent as part of the preview. 115. Such an indication may be an active, manual indication from a user through an input device (e.g., pressing a full-size download button on a touchscreen) or may be determined according to criteria such a viewing time (e.g., viewing a preview for more than 10, 15, 20, or 30 seconds triggers full-size download). Upon receipt of the indication for full size download, the server or other content-distributing computer sends the remaining segments to the user device 117. The user device is then operable to insert the remaining segments into the preview content to form the full-size media content for subsequent viewing 119.

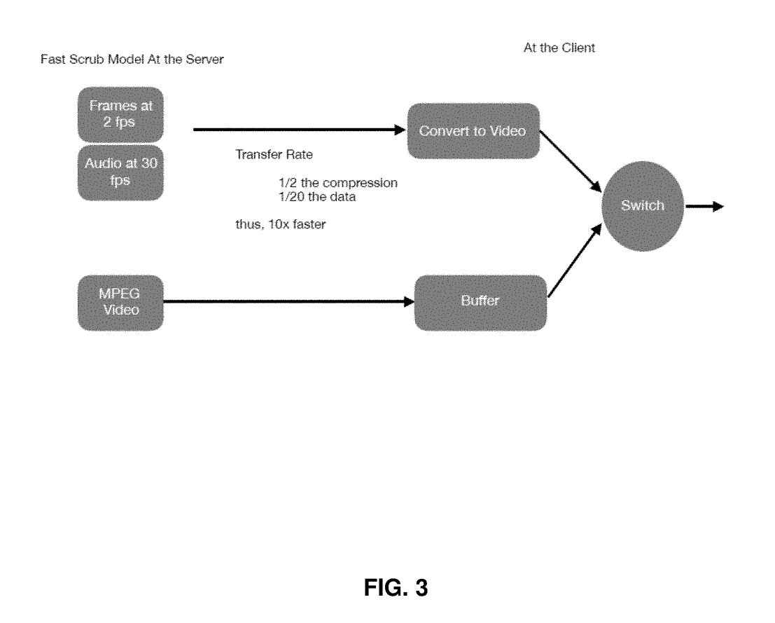

In some embodiments, preview files may appear temporally, spatially, and even in image quality to be the equivalent of the full-size content. Such preview files may offer the complete user interactive functionality of the full-size content (e.g., ability to fast forward, zoom, rotate, pan, scrub, slow down, etc.) and may have the full run time of the full-size content. In such cases, the size and download time of the preview file may still be reduced by reducing frame rate, resolution, or compression of the full-size content. For example, a full piece of content may include a 30 second video recorded at 60 frames per second (fps). A preview file may omit every other frame so that the video still appears to be 30 seconds long but plays at 30 fps. Frame rate can be reduced by any amount such that the content is still acceptable for user consumption and evaluation as a preview. Reductions in frame rate are particularly useful in fast forward and scrubbing is essentially a reduced frame rate so it's all gravy where that's what a user is doing to the preview. As shown in FIG. 3, a piece of video content may be recorded at 30 frames per second (fps). Using the component model discussed below, the audio component may be maintained at 30 fps equivalent while the image or video component may be reduced to 2 fps. The resulting preview components may comprise 1/20th the data and can be transferred at ½ the compression to allow for the preview file to be transferred 10 times faster than the full-size file.

Also shown in FIG. 3 is a server-assembly model where a preview file is created at the server (e.g., an MPEG video) and then sent to the client device and buffered (i.e., delayed playback in order to minimize the risk of disrupting playback) before viewing. This model can also be used for full content downloads taking place in the background. For example, the preview video can download fast and be shown on the client device while the full size MPEG video is downloaded in the background and once the appropriate buffer is built up, the client device can switch to the full-size video playback. Transferring video and audio components separately is important to avoid noticeable audio clipping. Reduced frame rates may not disrupt the user experience because a single still image still conveys meaning to the viewer, missing pieces of audio however can seriously detract from enjoyment and even comprehension as a single bit of sound, without context of temporally adjoining sounds likely will not convey any meaning.

Using interactive preview models of the invention, the preview appears to a viewer to be unchanged in temporal and spatial scope from the full content, allowing the viewer a rewarding interactive experience, albeit at a reduced quality that may not even be perceived by the user. For example, where a user initially interacts with and evaluates a piece of content by quickly scrubbing through to various points or fast forwarding, a reduced frame rate will not be noticeable as less frame density is required. In certain embodiments, frame rate, resolution, and/or compression may be variable for different portions of the content. Those portions may be selected according to any of the criteria discussed above. In other words, the key or critical portion selection criteria described above may be used to identify components or sections of the content that are maintained at full frame rate in the preview while less important portions are transferred at a reduced framerate.

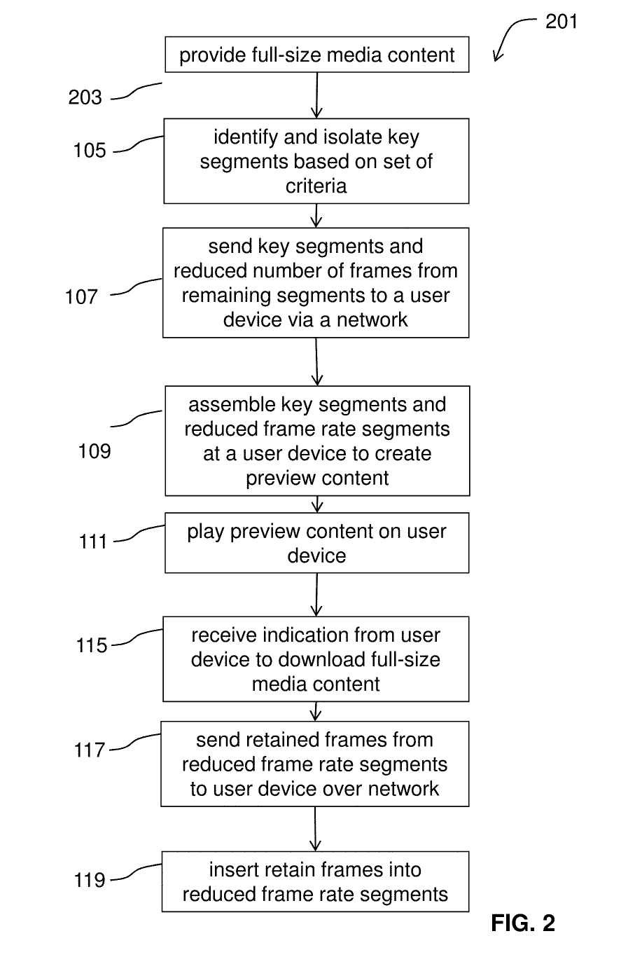

An exemplary method 201 for interactive preview is diagrammed in FIG. 2. Full size media content is provided 203 and key segments are identified an isolated 205 according to any of the criteria and methods described above. The key segments are then sent to a user device via a network along with a reduced number of frames from the non-key segments 207. The user device is then operable to assemble the key segments and reduced frame rate segments to create a comprehensive preview 209. The user device can then play the preview 211. An indication from the user device can then trigger the download of the remaining pieces of the content that were not sent as part of the preview (e.g., the frames missing from the reduced frame rate portions) 215. Upon receipt of the indication for full size download, the server or other content-distributing computer sends the remaining frames to the user device 217. The user device is then operable to insert the missing frames into the preview content to form the full-size media content for subsequent viewing 219.

While the above examples are given with particular focus on content containing video, the same principles can be applied to any audio or image based content by reducing the sampling rate or the resolution of various content portions to reduce preview file size. Visual and video-related methods described herein should be understood to contemplate and apply to virtual reality, augmented reality, and immersive reality experiences and content.

As noted above preview portions may also be selected on a spatial basis where a physical portion of displayed content is deemed more critical than another portion (e.g., the top corner of a video or image vs. the center). This concept is particularly applicable to virtual, augmented, or immersive reality content. With 3D video content, for example, a viewer cannot possible take in all simultaneously displayed images as some will appear virtually before the viewer while others appear virtually behind the viewer. The viewer can control the portion of the 3D environment that fills their screen or headset but the off-viewer information at any given time is not shown and its absence cannot be perceived by the viewer. Accordingly, the methods of key component selection described above can be used to determine, for example, both temporal and spatial portions of visual content that are more or less important and, accordingly, more or less likely to be viewed in a 3D viewing environment. The audience input methods described above may be of particular use in such embodiments as the most viewed portions of a 3D environment at any given time in a video can be recorded for each successive viewer and patterns may emerge indicating that certain spatial components, at certain times, are never or almost never viewed. Those spatial components can then be either omitted or sent at reduced size in a preview file according to the methods described herein.

Where reduced frame rate or resolution techniques are used, they may comprise a fixed reduction applied to all less important portions or may be variable. For example, where portions are rates on a scale or tiered, framerate may be reduced for the less important portions and reduced even more for the least important portions.

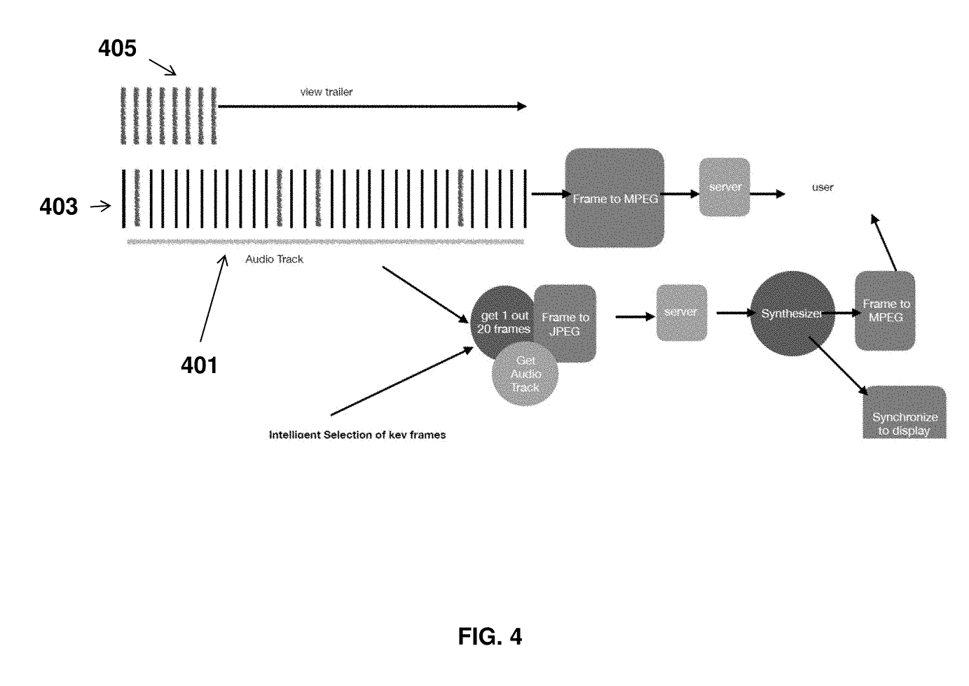

FIG. 4 shows a preview creating system according to certain embodiments. A full piece of multimedia content comprises an image portion 403 made up of a number of frames to be displayed in a certain order at a certain pace as well as an audio component 401. Methods of the invention may be applied to intelligently select key frames 405 of the image portion 403. Those frames 405 may be isolated along with the corresponding audio track portions and compiled into a trailer-type preview (e.g., an MPEG video) at a server and sent to a client or sent to a client and compiled there. Alternatively, a reduced number of frames such as every 20th frame can be isolated with playback instructed to be at 1/20th speed along with the full size audio component 401 and sent as components (e.g., frames converted to JPEG image files) to a client device for assembly or content synthesis as an interactive type preview as described herein.

With any type of preview described herein, during the preview, the full-size media content can continue downloading in the background. The omitted frames, pixels, or sections can be downloaded individually to fill in the portions missing from the preview so as not to require duplicative downloading of the preview portions. With reference to FIG. 4, in the trailer-type preview, the non-selected frames (i.e. 403 less 405) can be subsequently sent to a client device for assembly as the full size image component 403. In the interactive-type preview, the remaining 19 of every 20 frames can be sent as components (e.g., JPEG images) for subsequent assembly or synthesis as a full-size piece of content at the client device.

In interactive preview models, the missing frames or pixels can be filled in while the user is interacting with the preview so that the user experience is seamless. Critical or important portions or components (identified using the criteria discussed above) may be used to determine order of full quality downloads so that the most important content portions reach full quality first.

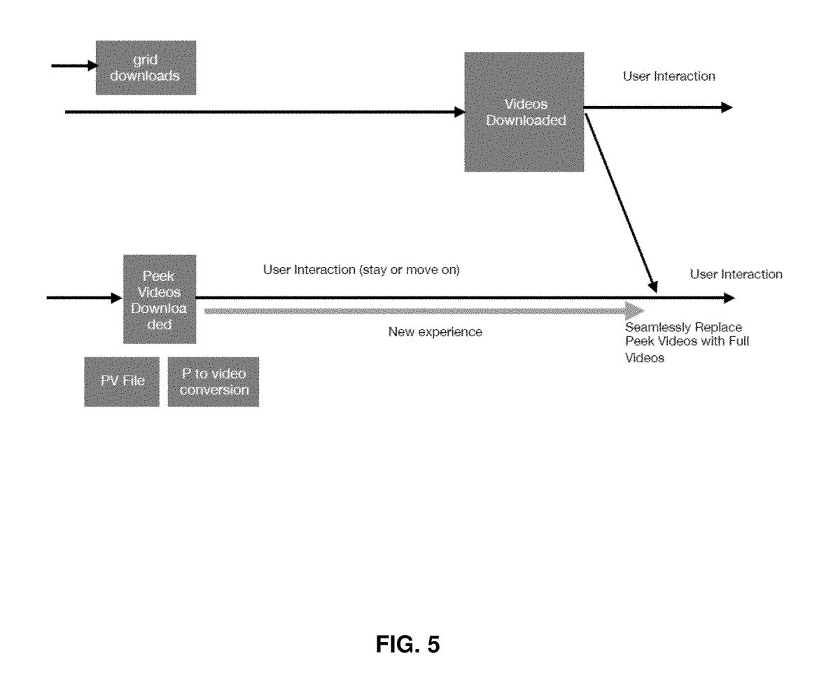

FIG. 5 compares legacy techniques and user experience to those afforded by the methods of the current invention. Using existing models, a grid of various content files downloads offering a selection to the viewer. The viewer may indicate a video they would like to download though clicking on a thumbnail on a grid for example. The video then downloads and, after download, the user can interact with the video. In streaming-type situations, interaction may begin before the entire video is downloaded but user interaction (e.g., scrubbing to a different time point in the video) will result in disruption and buffering as the newly requested portions are downloaded. Various embodiments of the methods of the invention can provide, for example, a grid of interactive previews for a user, allowing the user to interact with the preview files in a grid or a full-screen preview file while the frames excluded from the preview are downloaded in the background and seamlessly inserted into the content the viewer is interacting with.

Preview methods of the invention have particular application to live-streaming feeds to serve as a short recap bringing a new viewer up to speed on what they missed quickly so they can join the real-time stream. Key portions can be identified using any of the techniques discussed above in real-time during a streaming feed and then applied to provide a condensed or abridged summary of the key portions of the streaming content the view may have missed.

Content may include, for example, pre-existing, generated, or captured still images, audio, video, text, verbal annotations, vector graphics, or rastor graphics. Content may be generated or captured using an input device (described later) on a mobile device or other computing device. In preferred embodiments, content is a computer file capable of being read by a computing device or server of the system. A variety of known programs or applications may be used to generate or capture content and content may be in a variety of known file types including, for example, JPEG, GIF, MPEG, Quick Time File Format (QTFF), ASCII, UTF-8, MIME, .TXT, XML, HTML, PDF, Rich Text Format (RTF), and WordPerfect.

Content, according to systems and methods of the invention may be comprised of one or more components which may include one or more pieces of content data created by one or more authors and/or one or more editing parameters created by one or more editors or authors. Content or edited content, according to systems and methods of the invention may be compiled by a computing device or viewer/synthesizer computer program from components (e.g., content data and editing parameters) and output via an appropriate output device (e.g., a display device or speaker). Content may be public or private and these privacy parameters may be selected by an author or editor to apply to their individual component contribution to a piece of edited or collaborative content.

In certain embodiments, an author is an individual who sends content to the server through a communication network. Servers according to the invention can refer to a tangible, non-transitory memory coupled to a processor and may be coupled to a communication network, or may include, for example, Amazon Web Services, cloud storage, or other computer-readable storage. A communication network may include a local area network, a wide area network, or a mobile telecommunications network. In an exemplary embodiment, an author may upload or send content (e.g., a captured image in JPEG format) from a computing device (e.g., a mobile telephone) to a server. The computing device may utilize an application or a computer program configured to provide an interface through which the author may select content and direct the sending, uploading, or sharing of the content to the server. According to certain systems and methods of the invention, content transferred between the server and a computing device may be compressed and/or encrypted using a variety of methods known in the art including, for example, the Advanced Encryption Standard (AES) specification and lossless or lossy data compression methods.

Upon receiving content from an author, the server may assign an identifier to the content and store the content in its memory. In some embodiments an author or a computing device may assign an identifier to the content and upload the identifier to the server along with the referenced content. In certain embodiments, the identifier is an alphanumeric sequence which is randomly generated by the server. An identifier according to systems and methods of the invention may be unique for each piece of uploaded or received content. In some embodiments, an identifier may be assigned by a computing device before content is sent from the computing device to the server. In these embodiments, the content associated identifier can be sent to the server along with the content. In certain embodiments, the server may also associate the author with the received content.

In some embodiments, the identifier may be location based in that it may reference a fixed location, for example, a storage location on networked server, where the corresponding content may be accessed and received. In some embodiments, the identifier may be content based in that it references the substance of the content, independent of storage location, for example a file name or a portion of computer code specific to the content. In certain instances, identifiers may comprise a hash, such as a cryptographic hash which corresponds to the content or components thereof including editing parameters. In some embodiments, the identifier may include permission information.

In various embodiments, a user with whom content has been shared may receive an identifier which is associated with the content. The identifier may be received on a computing device and may be sent by another computing device or a server. A requestor, or user requesting content from the server, may send an identifier to the server through a computing device, over a communication network. In certain embodiments, the server may then access the content associated with the identifier and send a copy of the content, stored in the server's memory, to the requestor. The copy may be sent according to the methods described herein such that a preview of the content is sent as opposed to the full content file or before sending the full content file allowing viewer manipulation while the full file downloads in the background. In some embodiments, the requestor may also send user credentials to the server. Such user credentials may include, for example, a user name, password, electronic mail address, phone number, age, gender, interests, physical attributes, geographic location, education, nationality, or biometric and other sensory information. User credentials may be linked to a specific user, entered once into a computing device and stored in the memory of the computing device to be sent to the server long with content or content requests. In certain embodiments systems and methods of the invention may include the creation of an account in order to access and share content using the system. Creation of an account may include entering user credentials into a computing device and can include creating a user name to associate with the credentials. These user credentials can be uploaded through the communication network to the server and stored in the server's memory. The server, upon receiving the user credentials and the identifier from the requestor may compare the user credentials to any privacy parameter associated with the identified content. If the requestor falls within the privacy parameter, then the server may send the content or a volatile copy of the content to the requestor over the communication network. In some embodiments, the server may compare the user credentials from the requestor to volatility parameters received from the author and send a volatile copy of the content to the requestor which matches the volatility parameters associated with the individual content and/or the individual requestor. In certain embodiments, if the user credentials received from the requestor by the server are not within the privacy parameter associated with the requested content, the server may send a notification, through the communication network to the author indicating that a request for private content has been received and that the requestor is not currently permitted to receive the content. The notification may be sent, for example, as an electronic mail, a text message, or through a dedicated portal to a computing device (e.g., an author's mobile telephone) in communication with the server. The computing device, having received a notification may identify the requestor based on the received user credentials and/or prompt the author for permission to release the content to the requestor. In various embodiments, the author may send a one-off authorization to the server instructing the server to release private content to a particular requestor. In some embodiments, an author may revise the privacy parameter associated with the content on a computing device and send, through the communication network, an updated privacy parameter associated with a particular piece or group of content to the server.

In certain embodiments, the invention includes previewing content made up of separate content files and editing parameters. Previews may be of edited content synthesized from a piece of content with an editing parameter or set of editing parameters as described in U.S. Pat. No. 9,672,377. In such embodiments, critical portions for preview purposes may be selected based on the number of editing parameters referencing a certain component or segment of the content (e.g., more editing parameters indicate that the portion is more critical and should be included in a preview). In such embodiments, final content may be formed at a server or other computing device and a preview created before distribution. In other embodiments, components chosen as critical for preview purposes may include or exclude editing parameters. For example, an editing parameter consisting of a change to brightness may be deemed less important and so excluded from a preview file where, if the full content is eventually downloaded, the editing parameter will be incorporated and the brightness changed.

In certain embodiments, an author, editor, and/or requestor may be a human or a machine such as a computing device. For example, an author of content may be a networked device such as a heart rate monitor wherein the content may be, for instance, an electronic record of an individual's heart rate during a workout. A machine or a computing device may create content, share content, edit content and/or set privacy parameters for content automatically, according to parameters set by a human, and/or some combination thereof.

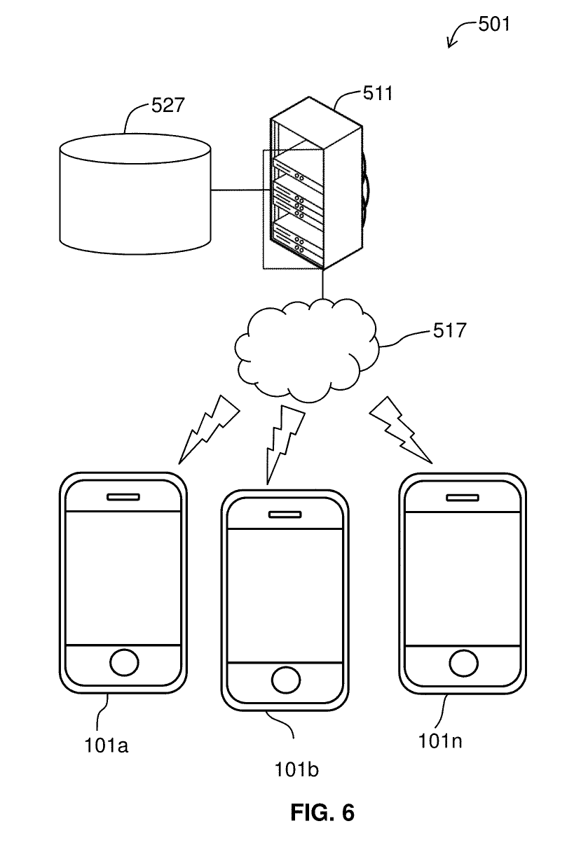

In various embodiments, systems 501 and methods of the invention may relate to a communication network 517 which allows a server 511 coupled to a data storage device 527 to send and receive data to and from any number of computing devices 101a, 101b, . . . , 101n. See FIG. 6. The server 511 of the system 501 may be operable to receive, for example, content, editing parameters, content identifiers, volatility parameters, content requests, user credentials, and/or privacy parameters from the computing devices 101a, 101b, . . . , 101n through the communication network 517 and can store them in its internal memory 307 or in a data storage device 527. The server 511 may be operable to send, for example, content, volatile content, content identifiers, editing parameters, notifications, and/or user credentials to the computing devices 101a, 101b, . . . , 101n through the communication network 517. Computing devices 101a, 101b, . . . , 101n according to systems and methods of the invention may be operable to send and receive content, volatile content, editing parameters, notifications, content identifiers, volatility parameters, content requests, user credentials, and/or privacy parameters through the communication network 517 from the server 511 and other computing devices 101a, 101b, . . . , 101n.

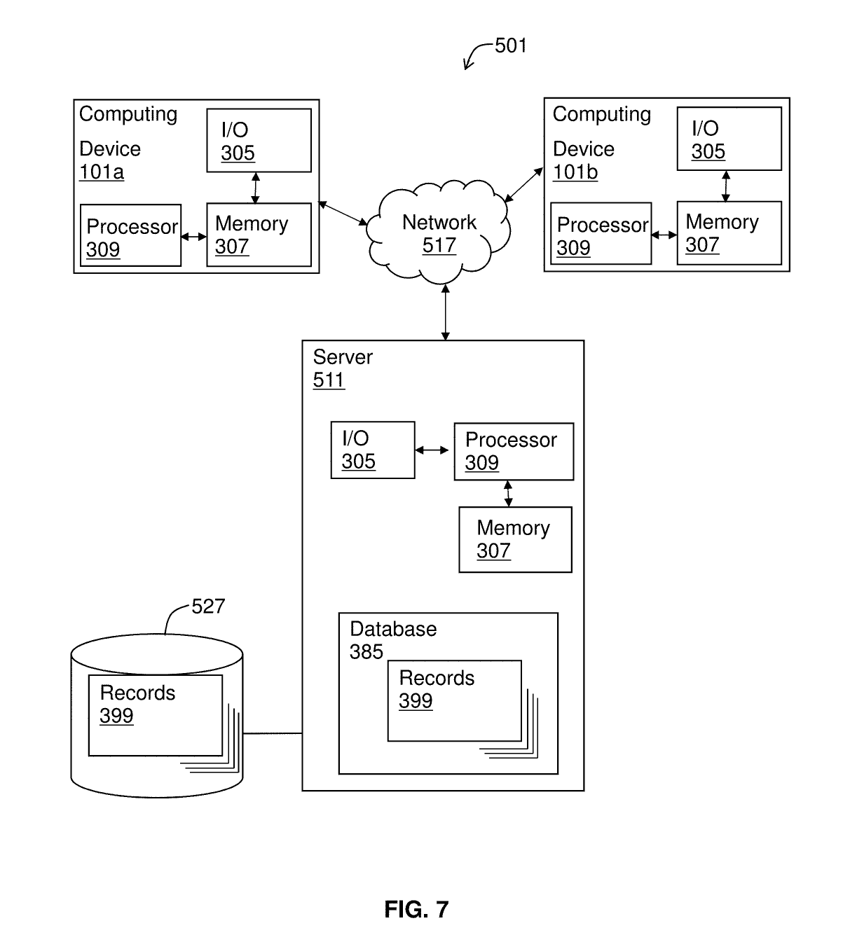

In a preferred embodiment, computing devices 101 according to the invention may provide a user, editor, or author, with an intuitive graphical user interface (GUI). FIG. 7 gives a more detailed schematic of components that may appear within system 501. System 501 preferably includes at least one server computer system 511 operable to communicate with at least one computing device 101a, 101b via a communication network 517. Sever 511 may be provided with a database 385 (e.g., partially or wholly within memory 307, storage 527, both, or other) for storing records 399 including, for example, content, editing parameters, content identifiers, volatility parameters, user credentials, preview templates, critical portion evaluation metrics, and/or privacy parameters where useful for performing the methodologies described herein. Optionally, storage 527 may be associated with system 501. A server 511 or computing device 101 according to systems and methods of the invention generally includes at least one processor 309 coupled to a memory 307 via a bus and input or output devices 305.

In certain embodiments, the role of the server within methods and systems of the invention may be performed by a distributed computing network or peer-to-peer file sharing network comprising a plurality of computing devices wherein the content, including components thereof, may be sent to, stored in, and/or sent from a plurality of computing devices. In such embodiments, content may be divided into individual components or subdivisions thereof which, in turn, may be received or downloaded from one or more separate computing devices in communication with the requestor's computing device via a communications network.

Content may be subdivided arbitrarily, or according to a scheme. An example of one scheme includes file size based division wherein a piece of content may be divided into a number of equally sized subdivisions where size is a measure of the amount of data (e.g., digital information), including, for example, subdivisions of 500 bytes, 1 kilobyte, 500 kilobytes, 1 megabyte, 10 megabytes, or 100 megabytes. Dividing the content and/or components thereof into subdivisions may allow for quicker data transfers (e.g., sending or receiving content; downloads or uploads) and the ability to pause and resume data transfers while retaining the already transferred subdivisions. Subdivisions may be arbitrary or based on separate components of the content (e.g., text component, audio component, video component, color information, privacy parameter, or editing parameter). In component based subdivisions, the subdivisions may each be substantially the same size or of varying sizes, for example to accommodate the size of each component.

In certain embodiments, content components and/or subdivisions thereof may be transferred among computing devices via a communication network. Content subdivision information may be included within an identifier. A requestor, having received a content identifier, may send a request to a plurality of computing devices acting as a server wherein each subdivision of the content (potentially subject to the privacy parameters described elsewhere) may be requested and received from any available source computing device that has a copy of the requested content subdivision available. The source computing devices may be selected based on a variety of factors including, for example, geographic proximity to the requestor, network access and speed, or network cost (e.g., on the same local network as a requestor, avoiding potential network or data transfer charges). Data transfer speeds may be increased through simultaneous downloads of content subdivisions by the requestor in cases where the bandwidth of the requestor is greater than that of a server comprising computing device.

In certain instances, individual subdivisions of a single piece of content may be requested, sent, and received at separate times and from different sources. In certain embodiments, the identifier may include information including data regarding division and assembly of the content or components thereof into subdivisions, security information, and/or tracking information such as possible sources of subdivisions or computing devices from which a particular subdivision may be requested and downloaded. In certain embodiments, the identifier may include security information such as a cryptographic hash which may be used to authenticate each subdivision as it is received.

In certain embodiments, content may be intelligently divided into components to enable efficient data transfers. For example, a video component may be compatible with several audio components in various languages (e.g., French, English, Mandarin, or Spanish) and a requestor wishing to view the video in Spanish could request and download the video component along with only the Spanish audio component, without wasting bandwidth on the other audio components.

In certain embodiments, systems and methods of the invention may relate so search functions wherein a requestor may input a query via an input device into a computing device which may review content, content identifiers, content components, or a catalog of any of the above in order to find data which matches the query. The computing device of the requestor may obtain such information from a server or another computing device and can display results on an output device connected to the requestor's computing device. In some embodiments, content may be searched for based on the information contained in the identifier allowing for faster cataloging and searching through stored content. For example, where an identifier contains information regarding component based subdivisions such as color information, a potential requestor may search for blue content and, instead of relying on tagging of blue images or a more complicated analysis of each file, a cursory search through of identifiers could recognize all available content with blue color information. In such embodiments, bandwidth and processing power may be utilized more efficiently.

Search results or any selection of media content may be provided to a user in a grid or other format showing many, smaller representations of the content files in a single screen. In certain embodiments, some or all of the smaller representations may comprise content previews as described herein such that each smaller representations shows a trailer-type preview or an interactive preview of the content they are representing. In some embodiments, an input device (e.g., mouse, touchpad, eye-tracking camera) may be used for a user to indicate content of interest from a grid or other selection of multiple pieces of media. Such a selection may be used to initiate a preview according to the invention while in other embodiments, the entire selection of content may constitute previews by default such that the initial download of a selection screen includes downloading previews for each piece of content shown in the selection screen.

The viewer/synthesizer program may compile the content for viewing from subdivisions of content based on compiling information which may be contained, for example, in the identifier.

As one skilled in the art would recognize as necessary or best-suited for the systems and methods of the invention, systems and methods of the invention include one or more servers 511 and/or computing devices 101 that may include one or more of processor 309 (e.g., a central processing unit (CPU), a graphics processing unit (GPU), etc.), computer-readable storage device 307 (e.g., main memory, static memory, etc.), or combinations thereof which communicate with each other via a bus.

A processor 309 may include any suitable processor known in the art, such as the processor sold under the trademark XEON E7 by Intel (Santa Clara, Calif.) or the processor sold under the trademark OPTERON 6200 by AMD (Sunnyvale, Calif.).

Memory 307 preferably includes at least one tangible, non-transitory medium capable of storing: one or more sets of instructions executable to cause the system to perform functions described herein (e.g., software embodying any methodology or function found herein); data (e.g., portions of the tangible medium newly re-arranged to represent real world physical objects of interest accessible as, for example, a picture of an object like a motorcycle); or both. While the computer-readable storage device can in an exemplary embodiment be a single medium, the term “computer-readable storage device” should be taken to include a single medium or multiple media (e.g., a centralized or distributed database, and/or associated caches and servers) that store the instructions or data. The term “computer-readable storage device” shall accordingly be taken to include, without limit, solid-state memories (e.g., subscriber identity module (SIM) card, secure digital card (SD card), micro SD card, or solid-state drive (SSD)), optical and magnetic media, hard drives, disk drives, and any other tangible storage media.

Any suitable services can be used for storage 527 such as, for example, Amazon Web Services, memory 307 of server 511, cloud storage, another server, or other computer-readable storage. Cloud storage may refer to a data storage scheme wherein data is stored in logical pools and the physical storage may span across multiple servers and multiple locations. Storage 527 may be owned and managed by a hosting company. Preferably, storage 527 is used to store records 399 as needed to perform and support operations described herein.

Input/output devices 305 according to the invention may include one or more of a video display unit (e.g., a liquid crystal display (LCD) or a cathode ray tube (CRT) monitor), an alphanumeric input device (e.g., a keyboard), a cursor control device (e.g., a mouse or trackpad), a disk drive unit, a signal generation device (e.g., a speaker), a touchscreen, a button, an accelerometer, a microphone, a cellular radio frequency antenna, a network interface device, which can be, for example, a network interface card (NIC), Wi-Fi card, or cellular modem, or any combination thereof.

One of skill in the art will recognize that any suitable development environment or programming language may be employed to allow the operability described herein for various systems and methods of the invention. For example, systems and methods herein can be implemented using Perl, Python, C++, C#, Java, JavaScript, Visual Basic, Ruby on Rails, Groovy and Grails, or any other suitable tool. For a computing device 101, it may be preferred to use native xCode or Android Java.

As used herein, the word “or” means “and or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for previewing content over a communication network, the method comprising:
receiving at a first computing device coupled to a communication network a request for a preview of a piece of content;
identifying key segments of the piece of content at the first computing device based on one or more criteria;
sending the key segments to a second computing device over the communication network;
assembling the key segments at the second computing device to create the preview;
sending a request for the piece of content from the second computing device to the first computing device over the communication network;
sending remaining segments from the first computing device to the second computing device over the communication network; and
combining the remaining segments with the key segments at the second computing device to recreate the piece of content.

2. The method of claim 1 wherein the piece of content one or more of an image, a video, a document, or an audio clip.

3. The method of claim 2 wherein the piece of content comprises a plurality of components selected from an image, a video, a document, an audio clip, or a combination thereof and the second computing device is operable to assemble the plurality of components to recreate the piece of content.

4. The method of claim 3 wherein the key segments are one or more of the plurality of components.

5. The method of claim 4 wherein the one or more criteria comprise component type or component size.

6. The method of claim 1 wherein the one or more criteria comprise a recording parameter.

7. The method of claim 6 wherein the recording parameter comprises a zoom, focus, recording speed, or movement of the recording apparatus.

8. The method of claim 7 wherein the recording parameter is determined from a sensor or input devices on a recording apparatus.

9. The method of claim 8 wherein the recording parameter is determined through analysis of the piece of content.

10. The method of claim 1 wherein the one or more criteria comprise an analysis of audience preferences.

11. The method of claim 10 wherein the audience preferences are determined from prior audience interactions with the piece of content.

12. The method of claim 10 wherein the audience preferences are determined from prior audience interactions with other content by a user associated with the second computing device.

13. The method of claim 1 wherein the one or more criteria are determined from analysis of the piece of content for one or more of an image of a category of object, an image of a specific object, or an audio cue.

14. The method of claim 1 wherein the piece of content is still recording and the key segments of the piece of content are identified and sent based on one or more criteria and an analysis of the piece of content at the time of the identifying and sending steps.

15. A method for previewing content over a communication network, the method comprising:
receiving at a first computing device coupled to a communication network a request for an interactive preview of a piece of content;
identifying key segments of the piece of content at the first computing device based on one or more criteria;
sending the key segments and a reduced number of frames of remaining segments to a second computing device over the communication network;
assembling the key segments and the reduced number of frames of the remaining segments at the second computing device to create the interactive preview;
sending a request for the piece of content from the second computing device to the first computing device over the communication network;
sending remaining frames of the remaining segments from the first computing device to the second computing device over the communication network; and
combining the remaining frames with the reduced number of frames of the remaining segments at the second computing device to recreate the piece of content.

16. The method of claim 1 wherein the one or more criteria comprise a recording parameter.

17. The method of claim 1 wherein the one or more criteria comprise an analysis of audience preferences.

18. The method of claim 10 wherein the audience preferences are determined from prior audience interactions with the piece of content.

19. The method of claim 10 wherein the audience preferences are determined from prior audience interactions with other content by a user associated with the second computing device.

20. The method of claim 1 wherein the one or more criteria are determined from analysis of the piece of content for one or more of an image of a category of object, an image of a specific object, or an audio cue.
